(19) United States
(12) Patent Application Publication
(10) Pub. No.: US 2009/0242641 A1
(43) Pub. Date: Oct. 1, 2009

(54) Multifunctional Data Capture Device

(76) Inventor: Matthew BLASCZAK, Coram, NY (US)

Correspondence Address: MOTOROLA, INC., 1303 EAST ALGONQUIN ROAD, IL01/3RD, SCHAUMBURG, IL, 60196, US

(21) Appl. No.: 12/059,551

(22) Filed: Mar. 31, 2008

(51) Int. Cl. G06K 7/10

(52) U.S. Cl. 235/462.1

(57) ABSTRACT

A device having a housing, a hybrid engine disposed within the housing, the hybrid engine configured to include components to perform at least two functionalities and an interface circuitry disposed within the housing to connect the hybrid engine to a processor using a single connector. The hybrid engine having a first set of components to perform a first functionality, a second set of components to perform a second functionality and a single connector connecting the hybrid engine to an interface circuitry of a device, the connector one of transmitting and receiving data relating to the first and second functionalities to a processor of the device.

### FIELD OF THE INVENTION

The present invention relates generally to a multifunctional data capture device. Specifically, the multifunctional data capture device minimizes functional redundancies present when more than one functionality is performable by the device.

### BACKGROUND

A data acquisition device may include components to enable, for example, a capturing and decoding of both one-dimensional and two-dimensional barcodes. These functionalities may be performed over a wide decode range and with a relatively small time to decode requirement. However, there may be several design challenges. For example, one possible design to enable these multiple functionalities is to use a two-dimensional imager design that utilizes auto-focus and auto-zoom technologies. However, this type of design comes with several added costs to manufacture such as an expensive bill of materials, slow decode times as the auto-focus and auto-zoom system stabilize, complicated illumination designs, etc. Furthermore, a fixed focus two-dimensional imager design may have a certain nominal performance level, but this level of performance may not necessarily have a desired overall working range.

In another example of a data acquisition device that captures/decodes both one-dimensional and two-dimensional barcodes, the device may include two scan engines. Specifically, one engine may be a fixed focus two-dimensional engine allocated primarily for two-dimensional barcodes and also for one-dimensional barcodes while the other engine may be a laser based scan engine allocated primarily for one-dimensional barcodes and certain two-dimensional barcodes. The performance of each scan engine compliments each other (i.e., provide a superset of barcode decoding performance that neither engine provides alone). However, in such a design, there is performance overlap (e.g., barcode types and ranges where one of the engines would be sufficient). There are also engine sub-functionality redundancies. For example, having both a two-dimensional image capture engine and a laser based barcode scan engine results in several common engine sub-functionalities (e.g., redundant optics, circuits, mechanical features, etc.). This redundancy inevitably increases costs of manufacturing the device as well as increases size requirements for a design solution.

### SUMMARY OF THE INVENTION

A device having a housing, a hybrid engine disposed within the housing, the hybrid engine configured to include components to perform at least two functionalities and an interface circuitry disposed within the housing to connect the hybrid engine to a processor using a single connector.

A hybrid engine having a first set of components to perform a first functionality, a second set of components to perform a second functionality and a single connector connecting the hybrid engine to an interface circuitry of a device, the connector one of transmitting and receiving data relating to the first and second functionalities to a processor of the device.

### DESCRIPTION OF THE DRAWINGS

FIG. 1 shows a data capture device according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a data acquisition device (“DAD”) configured to perform multiple functionalities. In one exemplary embodiment, a DAD is equipped with a hybrid engine to capture both one-dimensional and two-dimensional barcodes. As will be discussed below, the hybrid engine eliminates various redundancies present in a dual scan engine configuration yet maintains the efficiency associated therewith. The DAD and the hybrid engine will be discussed in further detail below.

It should be noted that the following description relates to capturing and decoding barcodes, specifically, one-dimensional and two-dimensional barcodes. However, this is only exemplary. According to the exemplary embodiments of the present invention, the DAD may capture/decode any symbol with data encoded therein. For example, the symbol may be the aforementioned barcodes, a color barcode, an image, an optical character recognition (OCR) string, etc. It should also be noted that the DAD may be a component of a mobile unit. That is, the mobile unit may include the data capturing functionality provided by the DAD of the exemplary embodiments of the present invention.

Furthermore, it should be noted that the hybrid engine being used for capturing and decoding barcodes is only exemplary. The exemplary embodiments of the present invention may also be applied to any two functionalities where redundancies exist. It should also be noted that the hybrid engine being used to eliminate redundancies in two functionalities is only exemplary. The exemplary embodiments of the present invention may also be used for more than two functionalities where redundancies exist.

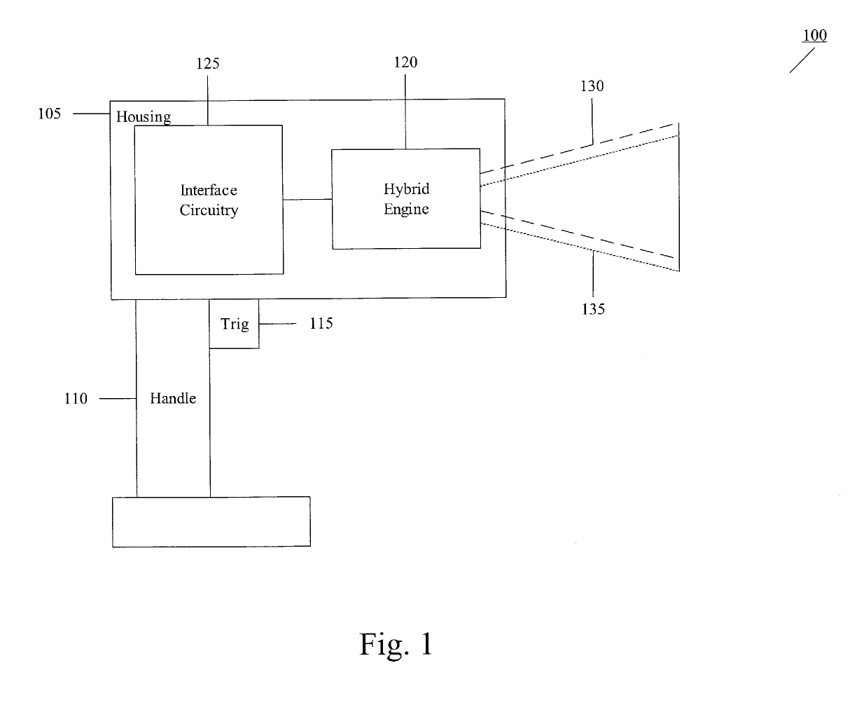

FIG. 1 shows a DAD 100 according to an exemplary embodiment of the present invention. The DAD 100 may be any data capturing device such as a barcode reader, an imager, a camera, etc. According to the exemplary embodiments of the present invention, the DAD 100 may include a housing 105, a handle 110, a trigger 115, a hybrid engine 120, and interface circuitry 125.

It should be noted that the DAD 100 may be manufactured as an original equipment manufacturer (OEM) device. That is, the DAD 100 may be housed without the handle 110, the trigger 115, etc. As an OEM device, the DAD 100 may still include the hybrid engine 120, the interface circuitry 125, etc. Thus, the DAD 100 may be incorporated into other devices to enable the features described below.

The housing 105 may provide a casing in which components of the DAD 100 may be at least partially disposed. That is, the components of the DAD 100 may be wholly or partially within the housing 105. For example, the DAD 100 may include a processor, a memory, a transceiver, etc. These components may be fragile and, therefore, be entirely disposed within the housing 105. In another example, the MU 100 may include a display, a data input arrangement (e.g., keypad), a scanner, etc. that may be disposed partially within the housing 105 so that a portion of these components are disposed on a periphery of the housing 105.

The handle 110 may provide a gripping surface in which a user may hold the DAD 100. The handle 110 may be oriented on the housing 105 or as part of the housing 105 (e.g., an extension) so that when held in a proper orientation, the data capturing functionalities may be performed. The trigger 115 may be, for example, a pistol trigger that actuates the data capturing functionality components. Thus, when the trigger 115 is activated (e.g., depressed), the data capturing functionality is performed. The trigger 115 may be disposed partially on the housing 105 and the handle 110 in a position configured to operate in the proper orientation.

It should be noted that the use of the handle 110 and the trigger 115 is only exemplary. The DAD 100 may not include the handle 110. For example, if the data capturing functionality is part of a mobile unit, the mobile unit may be hand-held with no handle. Furthermore, the mobile unit or the DAD 100 may include a display with a touch panel, keys, or other means for activating the data capturing functionality (i.e., without a separate trigger component).

The hybrid engine 120 may include components to execute at least two functionalities of the DAD 100. Specifically, according to the exemplary embodiments of the present invention, the two functionalities may be for capturing and decoding a one-dimensional barcode and a two-dimensional barcode. Accordingly, the components that the hybrid engine 120 may include are scanning engines associated therewith such as a laser based scan engine (e.g., primarily for the capturing and decoding of one-dimensional barcodes and for certain two-dimensional barcodes) and an imager engine (e.g., primarily for the capturing and decoding of two-dimensional barcodes and also one-dimensional barcodes), lighting components associated with the respective scanning engines, sensors associated with the respective scanning engines, etc. The hybrid engine 120 may be enclosed within a chassis according to an exemplary embodiment of the present invention. The chassis will be described in further detail below.

When the hybrid engine 120 includes components for a laser scanning sub-functionality and an imaging sub-functionality, a field of view (FOV) associated with each functionality may overlap. The FOV may define an area in which a scan may be performed. Thus, with, for example, a right angular measure, the FOV may be narrow. With, for example, an obtuse angular measure, the FOV may be broad. Furthermore, the FOV may be affected increased/decreased according to a distance in which the scanning engine is disposed with respect to an object. Each functionality may also incorporate a working range that defines a distance range in which the scanning engine is capable of capturing a scan.

According to the exemplary embodiments of the present invention, a first FOV 130 may be for the laser scanning functionality while a second FOV 135 may be for the imaging functionality. The overlapping of the FOV 130 with the FOV 135 enables a use of mutual data to improve performance for each sub-functionality. The mutual data will be discussed in further detail below. In addition, the working ranges for each functionality may improve performance. For example, if the laser scanning functionality includes a greater working range (e.g., 1-10 inches) than the imaging functionality (e.g., 2-5 inches), the working range of the imaging functionality may be increased to the working range of the laser scanning functionality.

In another example, if the imaging functionality includes a working range (e.g., 1-5 inches) that is not covered by the laser scanning functionality (e.g., 2-10 inches), the working range of the hybrid engine 120 may be extended in one direction (e.g. the near end of the overall working range) for one functionality and extended in the other direction (e.g. the far end of the overall working range) for the other functionality (e.g., 1-10 inches). That is, the hybrid engine 120 may obtain a union of the working ranges for each functionality to increase the working range of one or both functionalities. In another example, with the effective use of mutual information, (e.g. the imager making use of data obtained by the laser sub-functionality, or the laser sub-functionality making use of the data obtained by the imager), the working range of the hybrid engine 120 can be increased even further. For example, the laser functionality could make measurements (e.g. a distance estimation) that could be utilized by the imager (e.g. in a de-blurring algorithm), such that the imager has improved range performance. In another example, the imager functionality could make a similar measurement that could be utilized in a laser based range enhancement algorithm.

The interface circuitry 125 may be a component enabling a connection to be established between various components of the DAD 100 to, for example, a processor, a memory, etc. According to the exemplary embodiments of the present invention, the interface circuitry 125 may include the engine interface and the host interface. The interface circuitry 125 may also be included on a printed circuit board (PCB). The PCB may be mounted on, for example, a top surface of the chassis of the hybrid engine.

Prior architectures utilizing separate laser based scan engines and image engines include interface circuitry that must interface both engines as well as the host to the product. That is, the interface circuitry serves to communicate with a host device (e.g., a computer, a cash register, etc. using, for example, a universal serial bus, an RS-232, or other protocol) and each of the individual engines. For example, with the imager engine, the interface circuitry decodes a video signal received from the imager engine while, with the laser based engine, the interface circuitry either processes the decoded data (assuming a decoded laser engine) or perform a decode (assuming an undecoded laser engine). This design includes redundancies such as each engine including a respective microprocessor, chassis, laser, laser monitor, etc.

In contrast, the exemplary embodiments of the hybrid engine 120 eliminate redundancies associated with including a separate laser based scan engine and a separate image engine. These redundancies will be discussed in further detail below. Furthermore, those skilled in the art will understand that the hybrid engine 120 may utilize mutual data obtained from one of the engine functionalities to assist the other engine for increased performance. This will also be discussed in further detail below. Other advantages arise from the use of the hybrid engine 120 such as a common processor which will be discussed in further detail below.

As discussed above with reference to prior configurations with multiple engines, each type of engine typically uses a respective microprocessor that may, for example, be part of a PCB. An image capture only engine uses a microprocessor to communicate with its host and to communicate with the image sensor along with other miscellaneous tasks such as imager illumination signaling, laser signaling for an aiming pattern, etc. A laser barcode capture only engine uses a microprocessor to communicate with its host and to communicate with main functional blocks of the laser scanner including a laser drive, a motor drive, and a receiver/digitizer. The hybrid engine 120 enables a single engine architecture and, accordingly, only a single microprocessor (and single PCB) is needed. The microprocessor may be, for example, a low end microprocessor with enough general purpose input/output (GPIO) to drive the laser scanner sub-functions as well as the imager sub-functions and to communicate with the interface circuitry 125 using a single host interface.

Multiple engine configurations further require that the interface circuitry be driven through both hardware and software. For example, this requirement may be placed on the interface circuitry of driving two different engines, with two different communication protocols, etc. This requires the decoder processor in the interface circuitry to have enough GPIO to support both engines; have enough program memory allocated in software for the engine drivers; and have enough random access memory (RAM) to support operation of the two engines. In contrast, the hybrid engine 120 only utilizes a single interface with the interface circuitry 125. Thus, only one protocol and set of commands are needed to manage the two sub-functionalities performed by a laser scan engine and an imager engine of the hybrid engine 120.

Multiple engine configurations also require each engine to have a connector to connect to a flex cable. The flex cable connects the respective engine to the interface circuitry. Accordingly, a DAD with two engines requires a connector on both engines (increasing space on the engine) and two flex cables or a complicated Y-shaped flex cable that occupies a position (e.g., a pin) on the interface circuitry. The hybrid engine 120 eliminates the need for the multiple hardware components (e.g., connectors, flex cables, etc.). That is, only one engine connector is required on the hybrid engine 120 and only one flex cable is required to connect the hybrid engine 120 to the interface circuitry 125, thereby only requiring a single position (e.g., pin) on the interface circuitry 125. In addition, those skilled in the art will understand that a laser scanning engine and an imaging engine may include a common set of data types. For example, if the engines are configured to decode the captured data, this data that is transmitted through the respective flex cable is of a common form between the two engines. The single flex cable for the hybrid engine 120 may further remove the redundant pathways for common data types.

Both a laser scan engine and an imager engine include a monitoring of a redundant laser monitor signal (typically generated by a redundant photodiode) for laser safety. The laser is an expensive component for an engine's bill of material. The laser is also a critical component for both types of engines. The laser serves to create an aiming pattern for the imager engine, for example, using diffractive optics to shape a static aiming pattern. The laser serves to illuminate a barcode for the laser scan engine where a return signal is used for decoding.

The hybrid engine 120 utilizes a single laser that accommodates both sub-functionalities of the laser scanning and the imaging. Therefore, only a single laser drive circuit controlled by the single microprocessor is necessary. The single laser of the hybrid engine 120 also enables a use of a single laser monitoring photodiode, thereby reducing a bill of material.

The laser of the hybrid engine 120 may be optimized (e.g., focusing) for the laser scanning engine sub-functionality. However, it should be noted that the laser may also be used for an aiming pattern for the imager sub-functionality. For example, when capturing an image with the hybrid engine, between camera exposures, the laser may either be in an “aim mode” where the laser produces, for example, a single dot. In another example, the laser may be scanning in between camera exposures with a reduced scan angle so that a small laser scan line may be used as an aiming pattern for the imager sub-functionality. In yet another example, the laser may be toggled between an on position and an off position while a laser line is scanning, thereby yielding a dotted laser line as an aiming pattern for the imager. According to the exemplary embodiments of the present invention, the use of a reduced scan line, an aiming dot, or a dotted line does not incur costs associated with a diffractive element.

According to an exemplary embodiment of the present invention, a switchable diffractive grating (not shown) may be disposed over the laser emitter of the hybrid engine 120. The grating may optimize the aiming pattern for the imaging sub-functionality. A diffractive pattern may either be electro-mechanically moved in front of the laser using a bi-stable motor or may be electro-optically switched on/off using techniques of electrically controllable diffractive grating (e.g., electrically switchable holographic optical element (ESHOE)). The grating may also be disposed beyond an extreme of the scan line so that the motor drives beyond the normal laser scan position and held in place by the motor drive circuitry. It should be noted that the grating may be used with the imaging sub-functionality but may be removed for the laser scan sub-functionality.

Each of the engines in the multiple engine configuration for the DAD is typically built in a framework of a chassis. There has been little compatibility between a mounting of different chassis of different engines. The hybrid engine 120 enables one standardized chassis to be used. That is, the hybrid engine 120 facilitates an integration of the DAD 100, especially in systems that require the laser scanning functionality only, imaging functionality only, or both. A single mechanical chassis also lowers an overall cost of manufacturing the chassis. The mounting for each engine in the multiple engine configuration also requires additional securing hardware (e.g., mounting bracket and associated screws). The hybrid engine 120 with the standardized chassis also reduces these securing measures that are required for the housing 105. The single mechanical chassis further allows the PCB in which the integrated circuit may be mounted to be of a singular form to accommodate the various types of sub-functionalities that the hybrid engine 120 may perform.

As discussed above, the hybrid engine 120 may also use mutual data associated with each sub-functionality. That is, one of the sub-engines may obtain data from the other sub-engine in order to increase performance thereof such as decoding a barcode. In a first example, when the hybrid engine 120 includes one sub-functionality associated with the imaging scan engine, a captured image may be too blurry so that the imager portion of the hybrid engine 120 cannot perform a decode, even with its own deblur algorithms. However, by analyzing the characteristics of the blur obtained, the imager may calculate certain parameters such as an estimated distance to the target barcode. This information obtained by the imager may then be used by the laser scan engine sub-functionality of the hybrid engine 120. The laser scanning sub-engine may then use the information from the imager sub-engine, in conjunction with its own measurement of parameters. For example, the laser scanning sub-functionality may perform its own various deblur algorithms using the combined data. In another example, it may adjust some of its other parameters such as gain based on the information from the imager.

In a second example of using mutual data, when the hybrid engine 120 includes one sub-functionality associated with the laser scanning engine, the signal from the laser based scanner may not be directly decodable. In this example, the signal from the laser sub-engine may be analyzed. Estimates may be made about the distance to the target. This information may be shared with the imaging sub-engine, which may then use this information for image deblurring.

In a third example of using mutual data, the imager sub-engine may have decoded a barcode. However, the imager sub-functionality may not be certain if there is a misdecode. The laser based sub-engine may likewise perform a decode, also with uncertainty if a misdecode has happened. The decoder, upon successful comparison of the same decode data from the two sub-engines, may then proceed with reporting the decode event, for example with an audible beep and/or visual feedback, with a lower probability of a misdecode.

In a fourth example of using mutual data, there may be many barcodes within the FOVs. However, there may be too many barcodes that the imager may be not clear as to which to report the decode. In this example, the laser based engine may generate a full or partial scan line which may be used as a pointer, such that the imager issues a decode based on which barcode is “painted” by the laser scan line. Here, the mutual information is performed optically, rather than communicated electronically.

In a fifth example of using mutual data, the mutual data may be used when the imaging sub-functionality includes a focusing technology associated therewith. That is, variable focal distances may be determined using, for example, a mechanical zoom, a liquid lens, an optical phase plate, electrically controllable diffractive optical techniques, etc. With focusing technologies, a fast convergence to the optimal focusing distance is ideal. The laser scanning sub-functionality may be used to increase an efficiency associated with the focusing technology. Specifically, the laser scanning sub-functionality may be used to estimate a distance to a target using, for example, pulsed techniques of distance estimation, analysis of a signal to estimate an amount of blur, etc. The resultant data may be used by the imaging sub-functionality to quickly converge on an optimum focusing setting rather than executing conventional steps of going through a predetermined focusing range, capturing images, and analyzing a sharpness of each image along the dynamic focusing range.

In a sixth example of using mutual data, the mutual data may be used for an illumination feature of the hybrid engine 120. Specifically, as discussed above, the hybrid engine 120 may include a signal sensor photodiode. The signal sensor photodiode may gather reflected laser light from the barcode for the laser scanning sub-functionality. The signal sensor photodiode may further serve as an ambient light sensor for the imaging sub-functionality. The imaging sub-functionality may be aware of the ambient lighting levels provided by the signal sensor photodiode. Thus, the imaging sub-functionality may start decoding faster than when having to determine the lighting levels. For example, the imaging sub-functionality may utilize an optimum gain and/or exposure settings on a first decode attempt using the mutual data. If the signal sensor photodiode senses that there is high ambient lighting, the first imaging attempt may be made without turning on an imaging illumination, thereby minimizing power consumption, preventing over-exposure, etc. If the signal sensor photodiode senses that there is low ambient lighting, the imaging sub-functionality may use this information to calculate an amount of imaging illumination, how much imager gain, exposure time required, etc. It should be noted that the hybrid engine 120 may further include a laser monitor photodiode.

Those skilled in the art will understand that the above examples illustrate an improvement in efficiency with utilizing the sub-functionalities of the hybrid engine 120. For example, power consumption may be reduced; battery life of the DAD 100 may be improved (e.g., using the imaging illumination only when required such as when there is low ambient lighting instead of always using the imaging illumination even when there is sufficient ambient lighting); etc. It should be noted that the above examples are only exemplary. The hybrid engine 120 may also include other examples where the mutual data of each sub-functionality is used to assist in the execution thereof.

It should be noted that the above description assumes that the hybrid engine 120 includes at least two sub-functionalities. However, the hybrid engine 120 enables a more efficient manufacturing process as well as increased adaptability for multiple functionalities. As discussed above, among other things, the hybrid engine 120 enables a common chassis, mounting, etc. to be used in the housing 105 of the DAD 100. The hybrid engine 120 may also be manufactured with an individual housing that is configured to associate the different components of the various sub-functionalities (e.g., imaging, laser scanning, etc.). Thus, specific components may populate the hybrid engine 120 depending on a particular design and/or need. That is, the hybrid engine 120 may be individually configured for each user. For example, the DAD 100 may only be required to have the laser scanning sub-functionality. The hybrid engine 120 may include the components associated therewith. If the DAD 100 does not require the imaging sub-functionality, components such as a camera sensor, an imaging illumination device, a camera focusing system, etc. may not be included in the hybrid engine 120, thereby decreasing a bill of materials. It should also be noted that when the DAD 100 is required to have the imaging sub-functionality, the hybrid engine 120 is configured to be readily populated with the above components.

As discussed above, the microprocessor may be a low end microprocessor. The low end microprocessor may be a component of the hybrid engine (e.g., disposed within the housing 105) that controls the laser scanning and imaging sub-functionalities. However, it should be noted that the hybrid engine 120 may be connected to a high end microprocessor. The high end microprocessor may be a component of the hybrid engine (e.g., disposed within the housing 105). The high end microprocessor may also be disposed on a host or decoder printed circuit board (PCB) if the hybrid engine 120 is configured to perform a decoding.

For example, if the hybrid engine is an un-decoded engine, then the microprocessor may be a low end microprocessor that simply controls the basic tasks for managing both laser and imager functionality. In this case, the information captured that would need to be decoded (e.g., laser signal or video signal) may be sent through the interface to a high end microprocessor external to the hybrid engine for decoding. Alternatively, if the hybrid engine is a decoded engine, then the microprocessor on the hybrid engine may be a high end microprocessor for decoding right in the hybrid engine itself, in which case the high end microprocessor of the hybrid engine may also manage both laser and imager functionality (in which case the low end micro would not also be needed.)

When the hybrid engine 120 is connected to the high end microprocessor, the hybrid engine 120 is capable of multiplexing signals from the imaging sub-functionality and the laser scanning sub-functionality into a single video port using video signal support. For example, an imager scan engine requires its signal to be decoded. The video signal from a camera may be processed by the high end microprocessor via a video signal pin such that software then decodes the barcode from the image. A laser scanning engine may also utilize the video port of a high end microprocessor. Traditional digitizers often disregard or even erase data to digitize the signal. The hybrid engine 120 enables a system that performs the decode on a waveform level. That is, the hybrid engine 120 enables multiplexing of a video signal from the imaging sub-functionality and an analog signal from the laser scanning sub-functionality using a single video port.

The hybrid engine 120 enables a “hybrid” application-specific integrated circuit (ASIC) to be used. As discussed above, the IC may be embodied within the interface circuitry 125. In this embodiment, the IC is an ASIC. In the “hybrid” ASIC design, all components necessary for both imaging and laser scanning in addition to other functionalities such as radio frequency identification (RFID) may be embedded into the ASIC device. Thus, the ASIC may contain a laser drive, a motor drive and a receiver for laser scanning; a camera sensor driver, an imaging illumination driver, etc. for imaging; and circuitry for RFID, power management, microprocessor resetting, and other miscellaneous functionalities.

Those skilled in the art will understand that the above description of the hybrid engine 120 enables a combination of imaging performance and laser scanning performance into a single device with a standard interface in a form factor that is smaller and less costly than having a separate imager engine and a separate laser scanning engine. The hybrid engine 120 may be populated with selected components depending on the required functionalities. Thus, additional components increase the available functionalities that may be executed while reduced components decrease costs for the DAD 100. The hybrid engine 120 includes a single engine form factor (including mechanical, electrical and software form factor aspects) simplifies host architecture designs where the host architecture may incorporate a laser scanner, an imaging scanner, and a combination thereof. The common engine architecture of the hybrid engine 120 further enables leverage volumes on common components such as the chassis of the housing 105, which also reduces costs.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a housing;
a hybrid engine disposed within the housing, the hybrid engine configured to include components to perform at least two functionalities; and
an interface circuitry disposed within the housing to connect the hybrid engine to a processor using a single connector.

2. The device of claim 1, wherein the functionalities include a laser scanning functionality and an imaging functionality.

3. The device of claim 1, wherein the processor is one of a low end microprocessor and a high end microprocessor.

4. The device of claim 3, wherein the low end microprocessor includes a minimum general purpose input/output to drive the at least two functionalities.

5. The device of claim 3, wherein, when the processor is the high end microprocessor, the hybrid engine multiplexes signals from the at least two functionalities into a single port.

6. The device of claim 2, wherein one of the components of the hybrid engine produces a laser that services both the laser scanning functionality and the imaging functionality.

7. The device of claim 6, wherein one of the components of the hybrid engine is a signal sensor photodiode to monitor laser safety.

8. The device of claim 6, further comprising:
a diffractive grating disposed in front of the laser producing component to optimize an aiming pattern created by the laser for the imaging functionality.

9. The device of claim 1, wherein the housing includes a chassis in which the hybrid engine is disposed, the chassis being common independent of the components for the at least two functionalities.

10. The device of claim 2, wherein data of one of the laser scanning functionality and the imaging functionality is used for the other functionality.

11. The device of claim 10, wherein the data includes one of (a) a first returned laser signal data of the laser scanning functionality indicating an amount of blurriness associated with an image for the imaging functionality;
(b) a second returned laser signal data of the laser scanning functionality indicating a distance for a focus optimizing functionality of the imaging functionality; and
(c) an ambient lighting data of the laser scanning functionality indicating an amount of light to optimize a gain, exposure settings, and an imaging illumination of the imaging functionality.

12. The device of claim 2, wherein the hybrid engine multiplexes imaging signals and laser scanning waveform signals into a single video port.

13. A hybrid engine, comprising:
a first set of components to perform a first functionality;
a second set of components to perform a second functionality; and
a single connector connecting the hybrid engine to an interface circuitry of a device, the connector one of transmitting and receiving data relating to the first and second functionalities to a processor of the device.

14. The hybrid engine of claim 13, wherein the first functionality is a laser scanning functionality and the second functionality is an imaging functionality.

15. The hybrid engine of claim 14, further comprising:
a laser emitter producing a laser that services both the laser scanning functionality and the imaging functionality.

16. The hybrid engine of claim 15, further comprising:
a diffractive grating disposed in front of the laser emitter to optimize an aiming pattern created by the laser for the imaging functionality.

17. The hybrid engine of claim 14, further comprising:
a signal sensor photodiode to monitor laser safety.

18. The hybrid engine of claim 14, wherein data relating to one of the laser scanning functionality and the imaging functionality is used for the other functionality.

19. The hybrid engine of claim 18, wherein the data includes one of
(a) a first returned laser signal data of the laser scanning functionality indicating an amount of blurriness associated with an image for the imaging functionality;
(b) a second returned laser signal data of the laser scanning functionality indicating a distance for a focus optimizing functionality of the imaging functionality; and
(c) an ambient lighting data of the laser scanning functionality indicating an amount of light to optimize a gain, exposure settings, and an imaging illumination of the imaging functionality.

20. A device, comprising:
a housing;
a hybrid engine means for including components to perform at least two functionalities, the hybrid engine means disposed within the housing; and
an interfacing means for connecting the hybrid engine to a processor using a single connecting means, the interfacing means disposed within the housing.
